(19) United States
(12) Patent Application Publication
(10) Pub. No.: US 2021/0110005 A1
(43) Pub. Date: Apr. 15, 2021

(54) LICENSE MANAGEMENT APPARATUS, LICENSE MANAGEMENT METHOD, AND RECORDING MEDIUM STORING LICENSE MANAGEMENT PROGRAM

(71) Applicant: NEC Corporation, Tokyo (JP)

(72) Inventor: Yuusuke SUZUKI, Tokyo (JP)

(73) Assignee: NEC Corporation, Tokyo (JP)

(21) Appl. No.: 17/030,688

(22) Filed: Sep. 24, 2020

(30) Foreign Application Priority Data
Oct. 9, 2019 (JP) 2019-185630

(51) Int. Cl. G06F 21/10; G06F 21/12; G06F 11/30

(52) U.S. Cl. CPC G06F 21/105; G06F 2221/0762; G06F 11/302; G06F 21/12

(57) ABSTRACT

A license management apparatus includes: a determination part configured to, before an execution unit for an application, as a unit to which a license for execution of the application is issued, newly executes the application, determine whether a license of a first type is issuable to the execution unit that newly executes the application; a license issue part configured to, when the license of the first type is not issuable, issue a license of a second type to the execution unit that newly executes the application; and a control part configured to control the execution unit in such a way that the execution unit executes the application using the license of the second type. The license management apparatus thus rapidly adds an execution environment for a new application even when the execution environment is difficult to rapidly add because of a problem on license management.

This application is based upon and claims the benefit of priority from Japanese Patent Application No. 2019-185630, filed on Oct. 9, 2019, the disclosure of which is incorporated herein in its entirety by reference.

### TECHNICAL FIELD

The present invention relates to a technique for managing a license for execution of an application.

### BACKGROUND ART

Recent computer systems implement a container environment, a virtualization environment or the like as an environment for executing application software (hereinafter, simply referred to as an “application”), thereby flexibly constructing an optimum configuration for service provision based on the application. With regard to an execution environment (e.g., a container or a virtual machine) for an application, such a computer system is subjected to dynamic scale out (i.e., addition of an execution environment) or scale in (i.e., reduction of an execution environment).

In order to execute an application, it is necessary to issue a license to an execution environment for the application. With regard to a system in which a configuration of an execution environment for an application is dynamically changed as described above, there is an increasing expectation for a technique capable of appropriately managing a license in such a way that the license is issuable to the execution environment.

According to the related art, JP 2010-267009A discloses a license management system including a plurality of computers connected to one another. In the system, when an application is launched on a virtual server, a license is permitted by license charge. According to the system, one of the computers determines a charge type, counts licenses according to a charge type based on a result of the determination, and transmits a result of the count to a server configured to permit a license. The server configured to permit the license determines whether the received count exceeds the number of licenses usable concurrently, and determines whether to permit the licenses, on the basis of a result of the determination.

JP 2008-234556A discloses a system for managing contract information on the number of different types of software usable concurrently. In the system, a server receives a software licensing request from a client. When the software complies with the contract information, and the number of licenses for the different types of software usable concurrently is equal to or less than the number of licenses based on the contract information, the server issues a license for the software to the client.

### SUMMARY

A main object of the present invention is to provide a license management apparatus and others capable of rapidly adding an execution environment for a new application even when the execution environment is difficult to rapidly add because of a problem on license management.

An aspect of the present invention provides a license management apparatus including:
at least one memory storing a computer program; and
at least one processor configured to execute the computer program to:
   determine, before an execution unit for an application, as a unit to which a license for execution of the application is issued, newly executes the application, whether a license of a first type is issuable to the execution unit that newly executes the application;
   issue, when the license of the first type is not issuable, a license of a second type to the execution unit that newly executes the application; and
   control the execution unit in such a way that the execution unit executes the application using the license of the second type.

From another point of view for achieving the foregoing object, an aspect of the present invention provides a license management method including:
by an information processing device,
determining, before an execution unit for an application, as a unit to which a license for execution of the application is issued, newly executes the application, whether a license of a first type is issuable to the execution unit that newly executes the application;
issuing, when the license of the first type is not issuable, a license of a second type to the execution unit that newly executes the application; and
controlling the execution unit in such a way that the execution unit executes the application using the license of the second type.

From still another point of view for achieving the foregoing object, an aspect of the present invention provides a computer-readable nonvolatile recording medium storing a license management program for causing a computer to:
determine, before an execution unit for an application, as a unit to which a license for execution of the application is issued, newly executes the application, whether a license of a first type is issuable to the execution unit that newly executes the application;
issue, when the license of the first type is not issuable, a license of a second type to the execution unit that newly executes the application; and
control the execution unit in such a way that the execution unit executes the application using the license of the second type.

### BRIEF DESCRIPTION OF THE DRAWINGS

FIG. 1 is a block diagram of a configuration of a license management system according to a first example embodiment of the present invention;

FIG. 2 is a diagram of exemplary details of license management information according to the first example embodiment of the present invention in a case of newly adding a container for executing an application;

FIG. 3 is a flowchart of an operation of a license management apparatus according to the first example embodiment of the present invention, specifically an operation of issuing a license to a container for executing an application when the container is added by scale out;

FIG. 4 is a diagram of exemplary details of a change criterion according to the first example embodiment of the present invention;

FIG. 5 is a diagram of exemplary details of the license management information according to the first example embodiment of the present invention in a case of changing a type of a license issued to a container, on the basis of an execution track record of and the change criterion for an application;

FIG. 6 is a flowchart of an operation of the license management apparatus according to the first example embodiment of the present invention, specifically an operation of changing a type of a license issued to a container, on the basis of the execution track record and the change criterion;

FIG. 7 is a block diagram of a configuration of a license management apparatus according to a second example embodiment of the present invention; and

FIG. 8 is a block diagram of a configuration of an information processing apparatus capable of embodying each of the license management apparatuses according to the first and second example embodiments of the present invention.

### EXAMPLE EMBODIMENTS

Example embodiments of the present invention will be described below in detail with reference to the drawings.

### First Example Embodiment

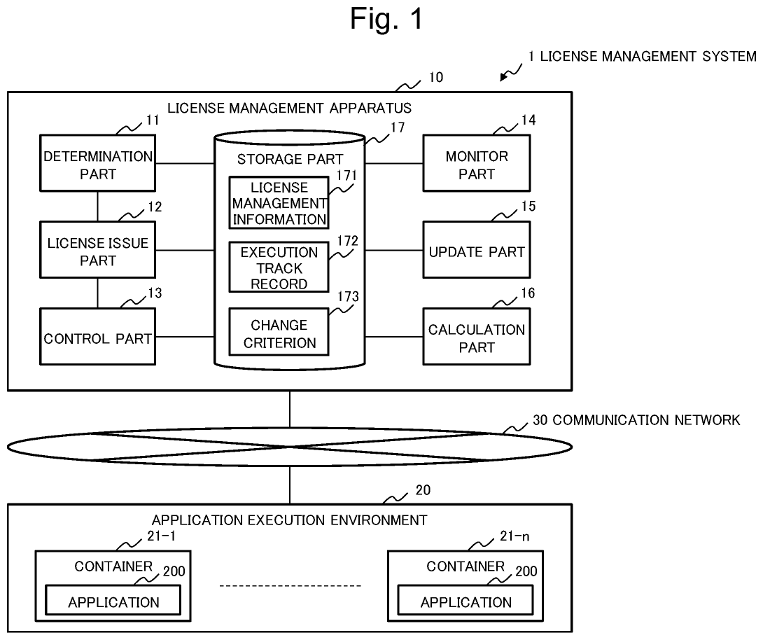

FIG. 1 is a block diagram of a configuration of a license management system 1 according to a first example embodiment of the present invention. The license management system 1 broadly includes a license management apparatus 10 and an application execution environment 20. The license management apparatus 10 is connected to the application execution environment 20 via a communication network 30 so as to communicate with the application execution environment 20. Examples of the communication network 30 may include the Internet and an intranet. The communication network 30 is established with, for example, a wide area network or a local area network.

The application execution environment 20 is an information processing apparatus such as one or more server apparatuses. The application execution environment 20 includes containers 21-1 to 21-n (n: any natural number). In the first example embodiment, the containers 21-1 to 21-n are collectively referred to as containers 21 in some cases. Alternatively, any of the containers 21-1 to 21-n is simply referred to as a container 21 in some cases. Each of the containers 21 is configured to execute an application 200.

The license management apparatus 10 according to the first example embodiment is configured to manage licenses issued to the containers 21 for executing the applications 200. In the license management system 1 according to the first example embodiment, the containers 21 are execution units for the applications 200 as units to which licenses are issued.

The license management apparatus 10 includes a determination part 11, a license issue part 12, a control part 13, a monitor part 14, an update part 15, and a storage part 17.

The storage part 17 is a storage device such as a hard disk drive or an electronic memory. The storage part 17 stores license management information 171, an execution track record 172, and a change criterion 173 each of which will be described later.

<Operation of Newly Issuing License to Container 21 Added by Scale Out>

First, a description will be given of an operation of the license management apparatus 10 according to the first example embodiment, specifically an operation of issuing a license to a container 21 for executing an application 200 when the container 21 is added by scale out.

When a container 21 for executing an application 200 is added by scale out in the application execution environment 20, the determination part 11 determines whether a license of a perpetual type (hereinafter, referred to as a “perpetual license” in some cases) is issuable to the container 21 that newly executes the application 200. A perpetual license is a license that requires no additional cost for execution of an application 200 after the purchase of the license. A perpetual license is an example of a license of a first type.

More specifically, the determination part 11 determines whether the containers 21 which have already executed the applications 200 are equal in number to perpetual licenses which have already been purchased (contracted), in the application execution environment 20. It is assumed herein that the determination part 11 is given the number of perpetual licenses which have already been purchased for the applications 200. The determination part 11 is capable of acquiring a license issue status on a container 21 by referring to the license management information 171 to be described later.

When the containers 21 which have already executed the applications 200 are smaller in number than the perpetual licenses which have already been purchased, the determination part 11 determines that a perpetual license is issuable to the container 21 that newly executes the application 200. When the containers 21 which have already executed the applications 200 are equal in number to the perpetual licenses which have already been purchased, the determination part 11 determines that a perpetual license is not issuable to the container 21 that newly executes the application 200.

The determination part 11 sends, to the license issue part 12, a result of the determination regarding the issue of the perpetual license.

The license issue part 12 issues a license to the container 21 that newly executes the application 200, on the basis of the result of the determination by the determination part 11. When a perpetual license is issuable to the container 21 that newly executes the application 200, the license issue part 12 issues a perpetual license to the container 21.

When a perpetual license is not issuable to the container 21 that newly executes the application 200, the license issue part 12 issues a license of a pay-per-use type (hereinafter, referred to as a “pay-per-use license” in some cases) or a license of a subscription type (hereinafter, referred to as a “subscription license” in some cases) to the container 21. Each of a pay-per-use license and a subscription license is an example of a license of a second type.

Next, a description will be given of a pay-per-use license and a subscription license. A pay-per-use license is a license that entails a cost in accordance with a usage record (e.g., an execution time) of an application 200. Specifically, a container 21 to which a pay-per-use license is issued entails a higher cost as the container 21 executes an application 200 many times. A subscription license is a license that entails a fixed cost every predetermined period (e.g., every month) irrespective of a usage record of an application 200. Specifically, a container 21 to which a subscription license is issued entails a higher cost as the container 21 executes an application 200 for a longer period.

Unlike a perpetual license, a pay-per-use license requires no cost at the time when a container 21 starts to execute an application 200. A subscription license entails, for example, a cost for the first one month from the time when a container 21 starts to execute an application 200. However, this cost is considerably lower than a cost for purchasing a perpetual license.

As is understood from the foregoing description that a container 21 for executing an application 200 is easily (i.e., rapidly) added by scale out, in such a way as to issue a pay-per-use license or a subscription license to the container 21, rather than to additionally purchase an expensive perpetual license.

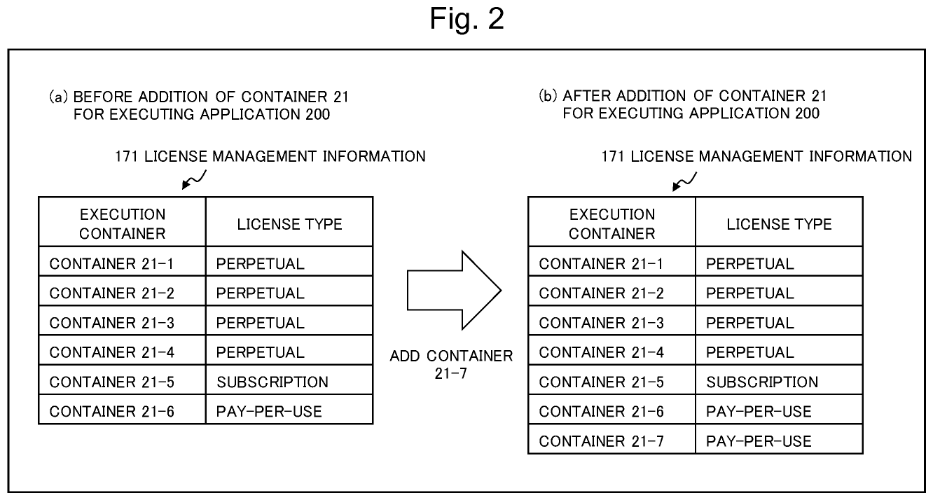

FIG. 2 is a diagram of exemplary details of the license management information 171 according to the first example embodiment. In FIG. 2, the left side (a) exemplifies the details of the license management information 171 before the new addition of a container 21 for executing an application 200. With reference to the left side (a) of FIG. 2, a perpetual license is issued to each of the containers 21-1 to 21-4, a subscription license is issued to the container 21-5, and a pay-per-use license is issued to the container 21-6. In the example illustrated in FIG. 2, the number of purchased perpetual licenses is “4” in the application execution environment 20.

In FIG. 2, the right side (b) exemplifies the details of the license management information 171 after the new addition of a container 21-7 for executing an application 200. In the example illustrated in FIG. 2, the determination part 11 determines that a perpetual license is not issuable to the container 21-7 that newly executes the application 200. The license issue part 12 issues a pay-per-use license to the container 21-7, on the basis of the result of the determination by the determination part 11. Also in the example illustrated in FIG. 2, the license issue part 12 may issue a subscription license to the container 21-7.

In the example illustrated in FIG. 2, when the license issue part 12 issues the pay-per-use license to the container 21-7, then the license issue part 12 updates the details of the license management information 171 exemplified in the left side (a) of FIG. 2 to those exemplified in the right side (b) of FIG. 2.

The control part 13 illustrated in FIG. 1 controls the container 21 in such a way that the container 21 executes the application 200 using the license which the license issue part 12 issues to the container 21. In the example illustrated in FIG. 2, for example, the control part 13 controls the container 21-7 in such a way that the container 21-7 executes the application 200 using the pay-per-use license which the license issue part 12 newly issues to the container 21-7.

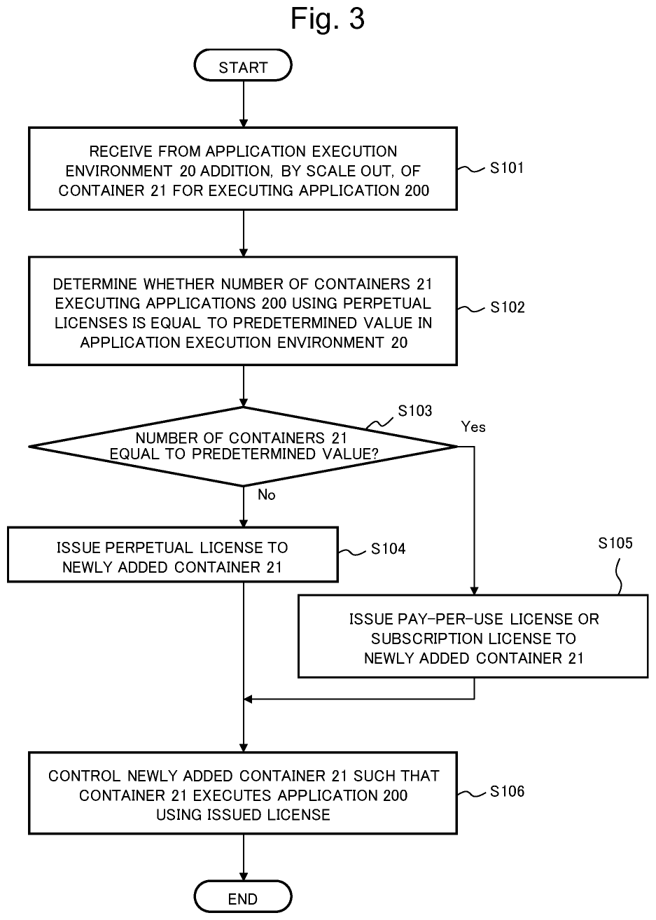

With reference to a flowchart of FIG. 3, next, a specific description will be given of an operation (a process) of the license management apparatus 10 according to the first example embodiment, specifically an operation (a process) of issuing a license to a container 21 for executing an application 200 when the container 21 is added by scale out.

The license management apparatus 10 receives from the application execution environment 20 the addition, by scale out, of a container 21 for executing an application 200 (step S101). The determination part 11 determines whether the number of containers 21 executing the applications 200 using the perpetual licenses is equal to a predetermined value (i.e., is equal to the number of purchased perpetual licenses) in the application execution environment 20 (step S102).

When the number of containers 21 executing the applications 200 using the perpetual licenses is different from the predetermined value (No in step S103), the license issue part 12 issues a perpetual license to the newly added container 21 (step S104). When the number of containers 21 executing the applications 200 using the perpetual licenses is equal to the predetermined value (Yes in step S103), the license issue part 12 issues a pay-per-use license or a subscription license to the newly added container 21 (step S105).

Next, the control part 13 controls the newly added container 21 in such a way that the container 21 executes the application 200 using the issued license (step S106). The entire process thus ends.

<Operation of Changing Type of License Issued to Container 21, as Required>

Next, a description will be given of an operation of the license management apparatus 10 according to the first example embodiment, specifically an operation of changing, as required, a type of a license issued to a container 21, on the basis of the execution track record 172 and the change criterion 173.

The monitor part 14 illustrated in FIG. 1 monitors a situation with regard to execution of an application 200 by a container 21 to which a pay-per-use license or a subscription license is issued for executing the application 200, in the application execution environment 20. The monitor part 14 monitors, for example, a time during the execution of the application 200 as the situation with regard to the execution of the application 200, and stores a result of the monitoring as the execution track record 172 in the storage part 17 to manage the execution track record 172.

The determination part 11 determines whether the type of the license issued to the container 21 for executing the application 200 is in need of change, on the basis of the execution track record 172 and change criterion 173 stored in the storage part 17. For example, the determination part 11 may make this determination periodically or may make this determination in accordance with a user's instruction.

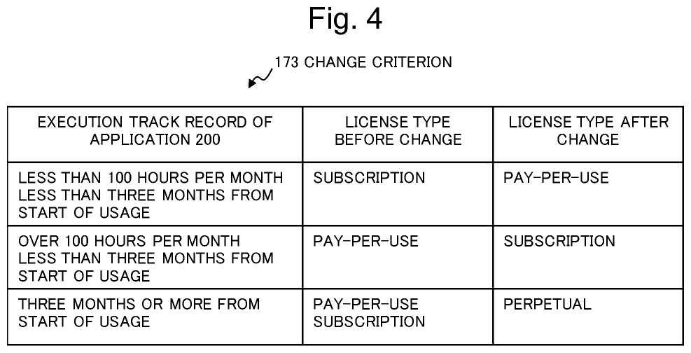

FIG. 4 is a diagram of exemplary details of the change criterion 173 according to the first example embodiment. The change criterion 173 illustrated in FIG. 4 indicates that in a case where a container 21 to which a subscription license is issued executes an application 200 for less than 100 hours per month and a period from a start of usage is less than three months, the issued license is in need of change to a pay-per-use license. The reason therefor is as follows. That is, in this case, the pay-per-use license is lower in cost for execution of the application 200 than the subscription license.

The change criterion 173 illustrated in FIG. 4 also indicates that in a case where a container 21 to which a pay-per-use license is issued executes an application 200 over 100 hours per month and a period from a start of usage is less than three months, the issued license is in need of change to a subscription license.

The change criterion 173 illustrated in FIG. 4 also indicates that in a case where a period from a start of usage of a container 21 to which a pay-per-use license or a subscription license is issued for executing an application 200 is equal to or more than three months, the issued license is in need of change to a perpetual license.

The determination part 11 illustrated in FIG. 1 sends, to the license issue part 12, a result of a determination as to the foregoing execution track record.

The license issue part 12 changes the type of the license issued to the container 21 for executing the application 200, to the type indicated by the change criterion 173, in accordance with the result of the determination by the determination part 11.

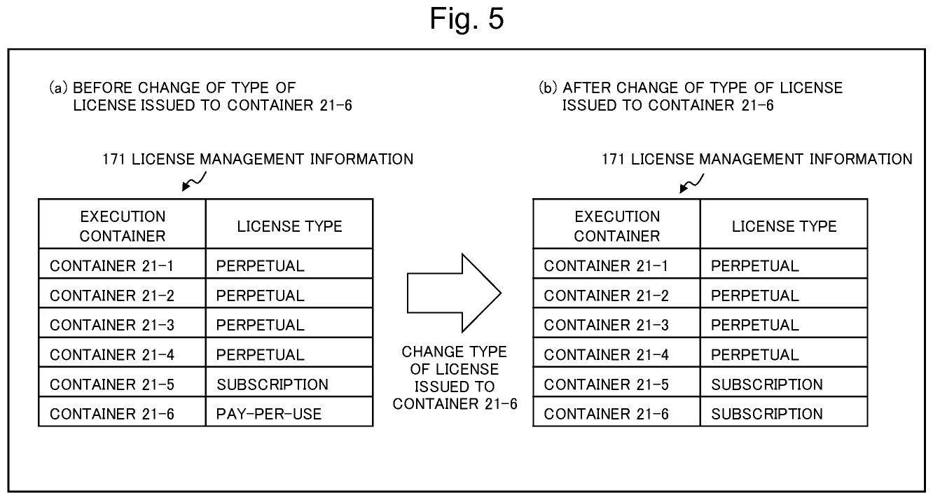

FIG. 5 is a diagram of exemplary details of the license management information 171 in a case of changing a type of a license issued to a container 21, on the basis of the execution track record 172 of and change criterion 173 for an application 200 according to the first example embodiment. In the example illustrated in FIG. 5, the monitor part 14, the determination part 11, and the license issue part 12 operate as described above to change the pay-per-use license issued to the container 21-6 to a subscription license.

For example, the change criterion 173 according to the first example embodiment is prepared by a user, and then is stored in the storage part 17. In addition, the change criterion 173 is updated by the update part 15 illustrated in FIG. 1. The update part 15 updates the change criterion 173 on the basis of, for example, information which the user inputs. Alternatively, the update part 15 may update the change criterion 173 in such a way that the cost for execution of an application 200 is minimized, on the basis of externally acquired information on a price schedule for the licenses of the respective types.

In the example illustrated in FIG. 5, the control part 13 illustrated in FIG. 1 controls the container 21-6 in such a way that the container 21-6 executes the application 200 using the subscription license, in accordance with the change in license which the license issue part 12 issues to the container 21-6, from the pay-per-use license to the subscription license.

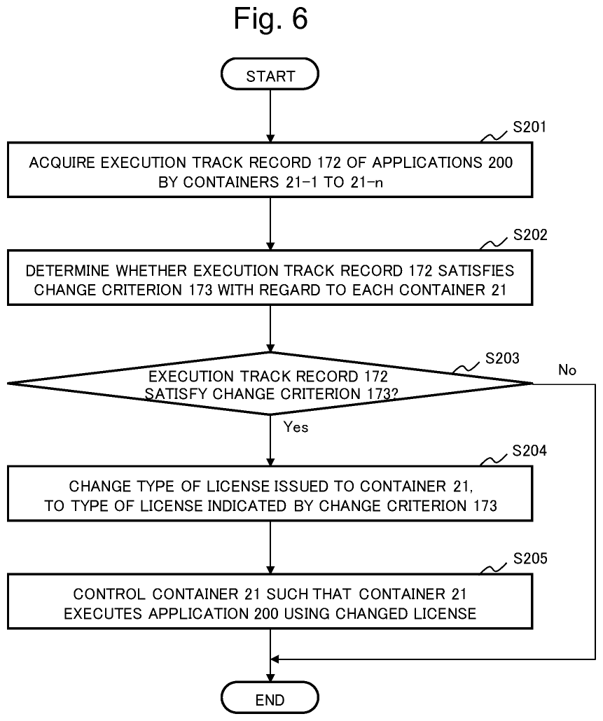

With reference to a flowchart of FIG. 6, next, a specific description will be given of an operation (a process) of the license management apparatus 10 according to the first example embodiment, specifically an operation (a process) of changing a type of a license issued to a container 21, on the basis of the execution track record 172 and the change criterion 173.

The monitor part 14 acquires the execution track record 172 of the applications 200 by the containers 21-1 to 21-n (step S201). The determination part 11 determines whether the execution track record 172 satisfies the change criterion 173 (i.e., whether the type of the license is in need of change) with regard to each container 21 (step S202).

When the execution track record 172 does not satisfy the change criterion 173 with regard to each container 21 (No in step S203), the entire process ends. When the execution track record 172 satisfies the change criterion 173 with regard to each container 21 (Yes in step S203), the license issue part 12 changes the type of the license issued to the container 21 to the type of the license indicated by the change criterion 173 (step S204). The control part 13 controls the container 21 in such a way that the container 21 executes the application 200 using the changed license (step S205). The entire process thus ends.

The license management apparatus 10 according to the first example embodiment is capable of rapidly adding an execution environment for a new application even when the execution environment is difficult to rapidly add because of a problem on license management. The reason therefor is as follows. That is, when a perpetual license is not issuable to a container 21 added by scale out in order for the container 21 to execute an application 200, the license management apparatus 10 issues a pay-per-use license or a subscription license to the container 21, thereby allowing the container 21 to rapidly start to execute the application 200.

Next, a specific description will be given of advantageous effects produced by the license management apparatus 10 according to the first example embodiment.

The execution of an application is typically permitted within a range of the number of licenses purchased from, for example, a vendor of the application. In a computer system implementing a container environment, a virtualization environment or the like, accordingly, in a case where applications have already been executed using purchased licenses, it is typically necessary to additionally purchase a license when a container is added by scale out for newly executing an application in the execution environment. In this case, it is necessary to perform processes, such as holding a contract and placing an order, for additionally purchasing the license. In a case of purchasing an expensive application, it is necessary to determine whether to purchase the application, from a business standpoint. In other words, it is difficult to rapidly add by scale out a container for executing an application in an execution environment in a state in which applications have already been executed using purchased licenses.

To solve the problem, the license management apparatus 10 according to the first example embodiment includes the determination part 11, the license issue part 12, and the control part 13, and operates as described above with reference to FIGS. 1 to 6. Specifically, before a container 21 (i.e., an execution unit for an application 200), as a unit to which a license for execution of the application 200 is issued, newly executes the application 200, the determination part 11 determines whether a license of a perpetual type (i.e., a first type) is issuable to the container 21 that newly executes the application 200. When the perpetual license is not issuable, the license issue part 12 issues a license of a pay-per-use type or a subscription type (i.e., a second type) to the container 21. The control part 13 controls the container 21 in such a way that the container 21 executes the application 200 using the pay-per-use license or the subscription license.

In other words, when a perpetual license is not issuable to a container 21 added by scale out, the license management apparatus 10 according to the first example embodiment issues, to the container 21, a pay-per-use license or a subscription license that allows the container 21 to easily start to execute an application 200. With this configuration, the license management apparatus 10 is capable of rapidly adding an execution environment for a new application even when the execution environment is difficult to rapidly add because of a problem on license management.

In addition, the license management apparatus 10 according to the first example embodiment monitors a situation with regard to execution of an application 200 by a container 21 to which a pay-per-use license or a subscription license is issued, thereby managing the execution track record 172 of the application 200. The license management apparatus 10 determines whether the type of the license issued to the container 21 is in need of change, on the basis of the execution track record 172 and the change criterion 173. When the type of the license issued to the container 21 is in need of change, the license management apparatus 10 changes the type of the license issued to the container 21. The license management apparatus 10 issues a license of an optimum type to the container 21 in accordance with the execution track record of the application 200. Therefore, the license management apparatus 10 avoids occurrence of a situation in which a cost increases since a pay-per-use license is issued to the container 21 although the container 21 executes the application 200 for a long time.

The license management apparatus 10 according to the first example embodiment also has the function of updating the change criterion 173 used for changing a type of a license issued to a container 21. With this configuration, even when a price schedule for licenses of the respective types is changed, the license management apparatus 10 updates the change criterion 173 in accordance with the change in the price schedule, thereby issuing a license of an optimum type to the container 21.

The license management apparatus 10 according to the first example embodiment may also include a calculation part 16 illustrated in FIG. 1. The calculation part 16 monitors a volume of data communications carried out by a container 21, to which a communication volume-restricted license (i.e., a license of a first type) presetting a maximum value of a cumulative value of a volume of data communications to be carried out by a container 21 for executing an application 200 is issued, thereby calculating the cumulative value of the data communication volume. The determination part 11 determines whether the cumulative value of the data communication volume calculated by the calculation part 16 reaches the maximum value. When the cumulative value of the data communication volume reaches the maximum value, the license issue part 12 issues to the container 21 a communication volume restriction lifting license (i.e., a license of a second type) permitting the cumulative value to exceed the maximum value. According to this configuration, even when the container 21, to which the license presetting the maximum value of the cumulative value of the data communication volume is issued, entirely carries out data communications by the permitted volume, the license management apparatus 10 allows the container 21 to continuously execute the application 200. In this case, the license management apparatus 10 may return the communication volume restriction lifting license issued to the container 21 to the communication volume-restricted license after a lapse of a predetermined time.

The application execution environment 20 according to the first example embodiment is not limited to a container environment including a container 21 as an execution unit to which a license for execution of an application 200 is issued. For example, the application execution environment 20 may be a virtualization environment including a virtual machine as the execution unit. For example, the application execution environment 20 may also be an execution environment including as the execution unit a device such as an edge server in an Internet of Things system.

The license management apparatus 10 according to the first example embodiment may allocate a license for execution of an application 200, for each user who uses the application execution environment 20 (i.e., each user who instructs to execute the application 200). In this case, the license management apparatus 10 manages user licenses. In this case, when the execution of an application 200 for which 10 user licenses (i.e., perpetual licenses) have already been purchased is required by an eleventh user, the license issue part 12 issues a license of a second type (i.e., a pay-per-use license or a subscription license) for the eleventh user. The license issue part 12 may issue, to an execution unit (e.g., a user, a container), a license of a third type that restricts an executable function of an application 200, rather than the license of the second type.

### Second Example Embodiment

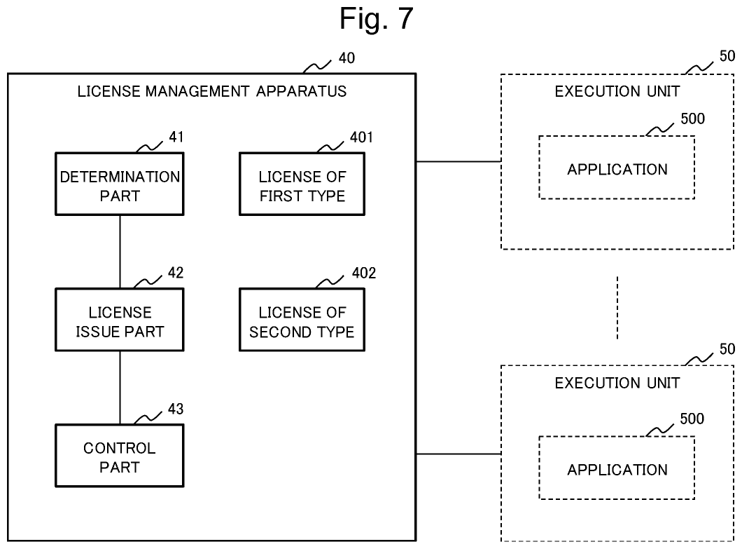

FIG. 7 is a block diagram of a configuration of a license management apparatus 40 according to a second example embodiment of the present invention.

The license management apparatus 40 according to the second example embodiment includes a determination part 41, a license issue part 42, and a control part 43.

Before an execution unit 50 for an application 500, as a unit to which a license for execution of the application 500 is issued, newly executes the application 500, the determination part 41 determines whether a license 401 of a first type is issuable to the execution unit 50 that newly executes the application 500. The determination part 41 makes this determination when receiving the addition of the new execution unit 50 from, for example, the execution environment including the execution unit 50 for executing the application 500. The determination part 41 sends a result of the determination to the license issue part 42.

For example, the execution unit 50 according to the second example embodiment may be a container 21 according to the first example embodiment or may be a virtual machine in a virtualization environment. For example, the license 401 of the first type according to the second example embodiment is a perpetual license according to the first example embodiment.

When the license 401 of the first type is issuable, the license issue part 42 issues the license 401 of the first type to the execution unit 50 that newly executes the application 500. When the license 401 of the first type is not issuable, the license issue part 42 issues a license 402 of a second type to the execution unit 50 that newly executes the application 500. For example, the license 402 of the second type according to the second example embodiment is a pay-per-use license or a subscription license according to the first example embodiment.

When the license issue part 42 issues the license 401 of the first type to the execution unit 50 that newly executes the application 500, the control part 43 controls the execution unit 50 in such a way that the execution unit 50 executes the application 500 using the license 401 of the first type. When the license issue part 42 issues the license 402 of the second type to the execution unit 50 that newly executes the application 500, the control part 43 controls the execution unit 50 in such a way that the execution unit 50 executes the application 500 using the license 402 of the second type.

The license management apparatus 40 according to the second example embodiment is capable of rapidly adding an execution environment for a new application even when the execution environment is difficult to rapidly add because of a problem on license management. The reason therefor is as follows. That is, the license management apparatus 40 issues, when the license 401 of the first type is not issuable to the added execution unit 50 in order for the execution unit 50 to execute the application 500, the license 402 of the second type to the execution unit 50, thereby allowing the execution unit 50 to rapidly start to execute the application 500.

<Exemplary Hardware Configuration>

In each of the license management apparatus according to the first example embodiment illustrated in FIG. 1 and the license management apparatus according to the second example embodiment illustrated in FIG. 7, the respective parts may be embodied by dedicated hardware (electronic circuitry). In FIGS. 1 and 7, at least the following constituent parts may be regarded as functional (processing) units (software modules) of a software program containing commands to be executed by a processor.
The determination parts 11 and 41.
The license issue parts 12 and 42.
The control parts 13 and 43.
The monitor part 14.
The update part 15.
The calculation part 16.
The storage control functions in the storage part 17.

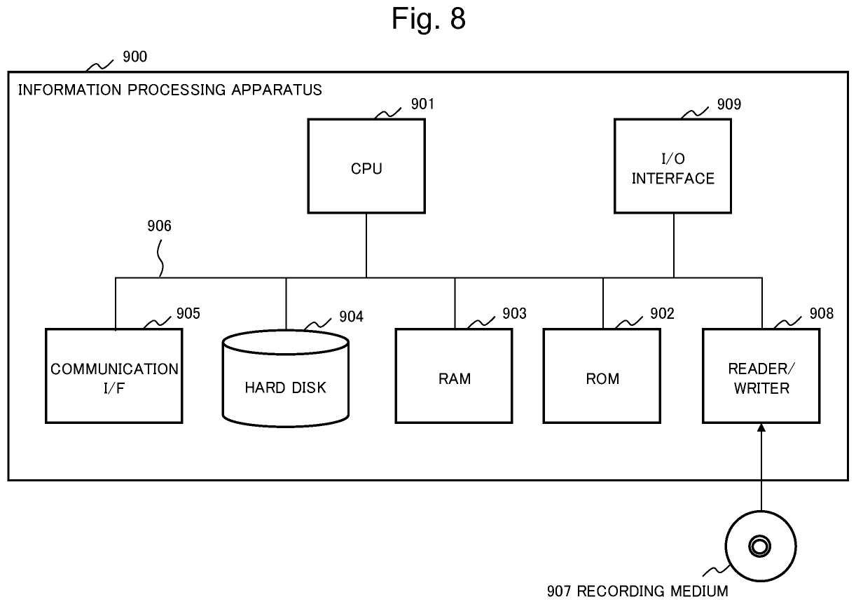

However, the division of the respective parts illustrated in these drawings is merely a configuration for convenience of the description. In actual implementation, various configurations may be assumed. With reference to FIG. 8, a description will be given of an exemplary hardware environment in this case.

FIG. 8 is a diagram of an exemplary configuration of an information processing apparatus 900 (a computer) capable of embodying each of the license management apparatuses according to the first and second example embodiments of the present invention. Specifically, FIG. 8 illustrates a configuration of a computer (an information processing apparatus) capable of embodying each of the license management apparatus illustrated in FIG. 1 and the license management apparatus illustrated in FIG. 7. That is, FIG. 8 illustrates a hardware environment capable of embodying the respective functions described in each of the first and second example embodiments.

The information processing apparatus 900 illustrated in FIG. 8 includes the following constituent elements.
A central processing unit (CPU) 901.
A read only memory (ROM) 902.
A random access memory (RAM) 903.
A hard disk (a storage device) 904.
A communication interface 905.
A bus 906 (a communication line).
A reader/writer 908 capable of reading and writing data from and into a recording medium 907 such as a compact disc read only memory (CD-ROM).
An input and output interface 909 such as a monitor, a loudspeaker or a keyboard.

In other words, the information processing apparatus 900 including the foregoing constituent elements is a typical computer in which these constituent elements are connected to one another via the bus 906. The information processing apparatus 900 may include a plurality of CPUs 901 or may include a multi-core CPU 901.

The present invention described by way of the foregoing example embodiments provides a computer program capable of embodying the following functions for the information processing apparatus 900 illustrated in FIG. 8. The functions are the foregoing configurations illustrated in the block diagrams (i.e., FIG. 1 and FIG. 7) referred in describing the first and second example embodiments or the functions illustrated in the flowcharts (i.e., FIG. 3 and FIG. 6). The present invention is achieved by loading the computer program into the CPU 901 of the hardware, interpreting the computer program, and executing the computer program. The computer program supplied to the apparatus may be stored in a readable and writable volatile memory such as the RAM 903 or a nonvolatile storage device such as the ROM 902 or the hard disk 904.

In the foregoing case, the method of supplying the computer program to the hardware may adopt a currently typical procedure. Examples of the procedure may include, but not limited to, a method of installing the computer program in the apparatus using the recording medium 907 such as the CD-ROM and a method of externally downloading the computer program via a communication line such as the Internet. In such a case, the present invention may be embodied as a code of the computer program or the recording medium 907 storing the code.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

1. A license management apparatus comprising:
at least one memory storing a computer program; and
at least one processor configured to execute the computer program to:
determine, before an execution unit for an application, as a unit to which a license for execution of the application is issued, newly executes the application, whether a license of a first type is issuable to the execution unit that newly executes the application;
issue, when the license of the first type is not issuable, a license of a second type to the execution unit that newly executes the application; and
control the execution unit in such a way that the execution unit executes the application using the license of the second type.

2. The license management apparatus according to claim 1, wherein the processor is configured to execute the computer program to:
determine whether a number of execution units to which a license of a perpetual type as the license of the first type is issued for executing the application is equal to a predetermined value; and
issue, when the number of execution units is equal to the predetermined value, a license of a pay-per-use type or a license of a subscription type as the license of the second type to the execution unit that newly executes the application.

3. The license management apparatus according to claim 2, wherein the processor is configured to execute the computer program to:
monitor a situation with regard to the execution of the application by the execution unit to which the license of the second type is issued, to manage an execution track record of the application;
determine whether the type of the license issued to the execution unit is in need of change, based on the execution track record and a change criterion; and
change, when the type of the license issued to the execution unit is in need of change, the type of the license issued to the execution unit from the pay-per-use type to the subscription type or from the subscription type to the pay-per-use type.

4. The license management apparatus according to claim 3, wherein the processor is configured to execute the computer program to:
change, when the type of the license issued to the execution unit is in need of change, the type of the license issued to the execution unit from the second type to the first type.

5. The license management apparatus according to claim 3, wherein the processor is configured to execute the computer program to:
update the change criterion used for changing the type of the license issued to the execution unit.

6. The license management apparatus according to claim 1, wherein the processor is configured to execute the computer program to:
issue, to the execution unit, a license of a third type that restricts an executable function of the application, rather than the license of the second type.

7. The license management apparatus according to claim 1, wherein the processor is configured to execute the computer program to:
monitor a volume of data communications carried out by the execution unit, to which the license of the first type is issued, the license of the first type presetting a maximum value of a cumulative value of a volume of data communications to be carried out by the execution unit for executing the application, to calculate the cumulative value of the data communication volume;
determine whether the cumulative value of the data communication volume being calculated reaches the maximum value; and
issue, when the cumulative value of the data communication volume reaches the maximum value, to the execution unit, the license of the second type permitting the cumulative value to exceed the maximum value.

8. The license management apparatus according to claim 1, wherein
the execution unit is one of a container, a virtual machine, a device in an Internet of Things system, and a user who instructs to execute the application.

9. A license management method comprising:
by an information processing device,
determining, before an execution unit for an application, as a unit to which a license for execution of the application is issued, newly executes the application, whether a license of a first type is issuable to the execution unit that newly executes the application;
issuing, when the license of the first type is not issuable, a license of a second type to the execution unit that newly executes the application; and
controlling the execution unit in such a way that the execution unit executes the application using the license of the second type.

10. A computer-readable nonvolatile recording medium storing a license management program for causing a computer to:
determine, before an execution unit for an application, as a unit to which a license for execution of the application is issued, newly executes the application, whether a license of a first type is issuable to the execution unit that newly executes the application;
issue, when the license of the first type is not issuable, a license of a second type to the execution unit that newly executes the application; and
control the execution unit in such a way that the execution unit executes the application using the license of the second type.
